(19) United States
(12) Patent Application Publication
(10) Pub. No.: US 2009/0198740 A1
(43) Pub. Date: Aug. 6, 2009

(54) DATA SHARING

(76) Inventors: Andrew BRAUN, Cary, NC (US); Yojak Vasa, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/023,262

(22) Filed: Jan. 31, 2008

(51) Int. Cl. G06F 17/30

(52) U.S. Cl. 707/201; 707/E17.01

(57) ABSTRACT

A system is provided for sharing data over a network. The system includes a plurality of portable electronic devices among which data may be shared, and a data share server through which data to be shared between the plurality of portable electronic devices is routed via the network. The data share server includes a data share unit for receiving data to be shared from a source portable electronic device among the plurality of portable electronic devices via the network, and for forwarding the data to be shared to a destination portable electronic device via the network. In addition, the data share server includes a data storage unit for copying the data to be shared and maintaining the copy for subsequent sharing among the plurality of portable electronic devices.

### TECHNICAL FIELD OF THE INVENTION

The present invention relates generally to data sharing and, more particularly, to a system and method for data sharing.

### DESCRIPTION OF THE RELATED ART

Computer networks are quite commonplace in today's society. Frequently, there is a need and/or desire to share data over such networks. With the proliferation of mobile phones and other types of portable electronic devices, there has been a dramatic increase in the use of mobile networks enabling communications and data sharing between respective portable electronic devices. In addition to typical voice communications, users of portable electronic devices want to share amongst themselves different types of data such as pictures, text messages, music, video, etc., over a network.

Recently, video sharing has become particularly popular with users of portable electronic devices. Video sharing involves a source device streaming video to a destination device via the network. This enables the source device to share video in real time with the destination device. The video may be captured by the video camera of the source device and shared by streaming the video to the destination device so that both may enjoy the event at the same time.

Sharing of large amounts of data (e.g., video data) requires substantial bandwidth within a network. Otherwise, data will take a very long time to be transmitted from the source device to the destination device. Such delay can result in inconvenience and/or discomfort to users at each end. In fact, insufficient bandwidth can preclude the streaming of real-time video data. In mobile phone networks, the available bandwidth is less than that found in other types of networks (e.g., LANs, WANs, the Internet, etc.). Thus, sharing video data sharing is particularly problematic in the context of mobile phone networks.

In view of the aforementioned problem, there is a strong need in the art for an improved system and method for sharing data. In particular, there is a strong need for a system and method having reduced bandwidth requirements for sharing data compared to conventional techniques.

### SUMMARY

According to an aspect of the invention, a system is provided for sharing data over a network. The system includes a plurality of portable electronic devices among which data may be shared, and a data share server through which data to be shared between the plurality of portable electronic devices is routed via the network. The data share server includes a data share unit for receiving data to be shared from a source portable electronic device among the plurality of portable electronic devices via the network, and for forwarding the data to be shared to a destination portable electronic device via the network. In addition, the data share server includes a data storage unit for copying the data to be shared and maintaining the copy for subsequent sharing among the plurality of portable electronic devices.

According to another aspect, for each copy of data maintained in the data storage unit, the data storage unit also includes an identification tag respectively associated with the copy.

According to yet another aspect, the data share unit provides the identification tag respectively associated with each copy of data to at least one of the plurality of portable electronic devices to enable the at least one of the plurality of portable electronic devices to initiate subsequent sharing of each copy of data between the data share server and one of the plurality of portable electronic devices.

In accordance with another aspect, the data share unit provides the identification tag associated with each copy of data to the portable electronic device which served as the source of the data when originally copied.

With still another aspect, the data share unit provides the identification tag associated with each copy of data to one of the plurality of portable devices other than the portable electronic device which served as the source of the data when originally copied.

According to another aspect, the data share unit is configured to receive a request to share each copy of data as identified by the associated identification tag, with one of the plurality of portable devices.

In still another aspect, the request to share is from the portable electronic device which served as the source of the data when originally copied.

According to another aspect, the request to share further includes the identity of the one of the plurality of portable devices with whom the copy of data is to be shared.

In accordance with still another aspect, the request to share is from a portable electronic device other than the portable electronic device which served as the source of the data when originally copied.

According to another aspect, the request to share is from the portable electronic device which served as the destination of the data when originally copied.

In yet another aspect, the request to share further includes the identity of the one of the plurality of portable devices with whom the given copy of data is to be shared.

According to another aspect, the data to be shared is video data.

In accordance with another aspect, the video data is streaming video data.

According to still another aspect, the data to be shared is streaming data.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an environmental view of a video share network in accordance with an exemplary embodiment of the present invention;

FIG. 2 is a table representing management information stored in a mobile phone in accordance with the exemplary embodiment of the present invention;

FIG. 3 is a table representing management information stored in a video share server in accordance with the exemplary embodiment of the present invention;

FIG. 4 is a block diagram of a mobile phone in accordance with the exemplary embodiment of the present invention;

FIG. 5 is a block diagram of a video share server in accordance with the exemplary embodiment of the present invention;

FIG. 6 is a flowchart suitable for programming operation of a mobile phone in accordance with the exemplary embodiment of the present invention; and

FIG. 7 is a flowchart suitable for programming operation of a video share server in accordance with the exemplary embodiment of the present invention.

### DETAILED DESCRIPTION OF EMBODIMENTS

The present invention will now be described with reference to the drawings, wherein like reference labels are used to refer to like elements throughout.

The present invention provides data sharing among portable electronic devices within a network using a data share server. The portable electronic devices share data amongst each another by streaming or otherwise transmitting data through the data share server and across the network. As is conventional, the data share server coordinates the linking of the portable electronic device representing the source of the data and the portable electronic device representing the destination for the data. Data shared between the source and destination devices is routed within the network through the data share server.

As discussed above, each time data is transmitted across the network it utilizes part of the network bandwidth. Thus, conventional data sharing consumes network bandwidth with respect to both transmitting the data from the source device to the data share server, and transmitting of the data from the data share server to the destination device. Each time a source device wishes to share data with a given destination device, the source device must transmit the data to the data share server and the data share server must transmit the data to the destination device. This can utilize considerable bandwidth usage.

The present invention overcomes such drawbacks by introducing additional functionality to the data share server. As will be discussed in more detail below, the data share server of the present invention not only routes shared data between a source device and a destination device. In addition, the data share server caches or otherwise copies the shared data and maintains such copy in memory in the event the source device wishes to share the data with another destination in the future. Specifically, the data share server in accordance with the present invention maintains a copy of previously shared data in a data vault. Each file of previously shared data has associated therewith an identification tag (i.e., form of indicia) that identifies the particular file. Consequently, should a source device later wish to share the previously shared data with another destination device (or again share the same data with the same destination device), the source device simply transmits to the data server information representing the identification tag and the identity of the intended destination device. The data share server in turn connects and transmits to the destination device the particular data stored within the data vault as identified by the identification tag.

Thus, the source device no longer is required to transmit the data to be shared to the data share server with respect to data that previously had been shared with the same or different destination device. This results in a substantial savings in network bandwidth as the source device need only transmit the identity of the data to be shared and the destination device.

Furthermore, a destination device may know the particular identification tag of data stored within the data vault. Such device may request from the data share server that the data be transmitted to the destination device itself. For example, the source device, data share server, or some other network device may have previously provided the destination device with information relating to the particular identification tag. Therefore, again the network is alleviated of the bandwidth required for the source device to otherwise retransmit the share data to the data share server in order to be shared with the destination device.

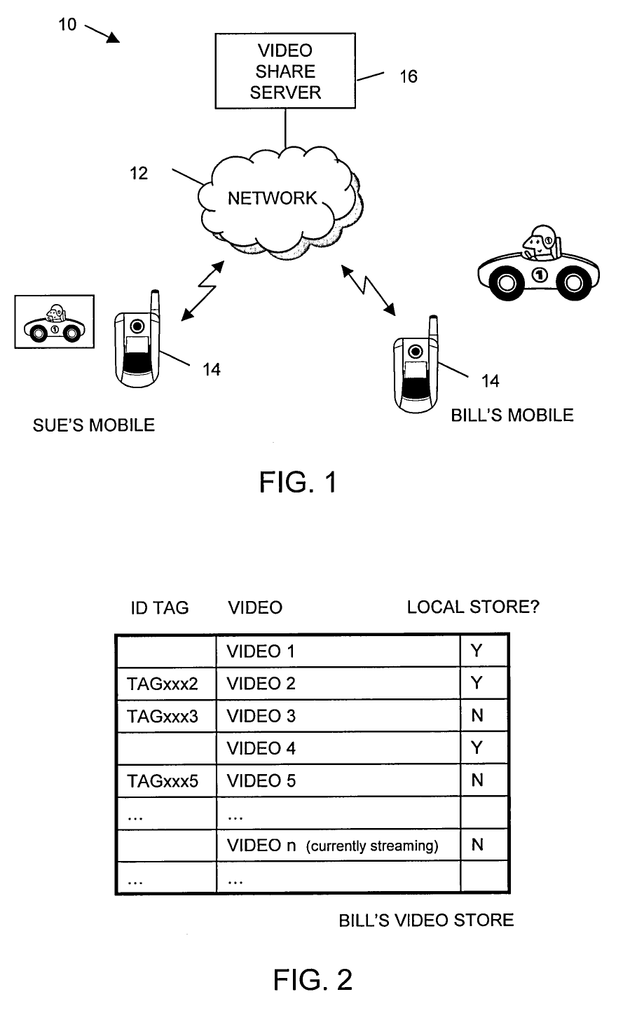

Referring to FIG. 1, a system 10 for sharing data over a network 12 is shown in accordance with an exemplary embodiment of the present invention. The present invention will be described in particular with respect to a network for sharing video data, and particularly for streaming video data from a source device to a destination device. However, it will be appreciated that the present invention in not limited to streaming video data in the broadest sense. Neither is the invention necessarily limited to video data as the data may be any type of data that users wish to share via the network 12.

The system 10 includes a plurality of portable electronic devices 14 between which data may be shared (e.g., via peer-to-peer networking). In the exemplary embodiment, the portable electronic devices 14 are mobile phones (e.g., Sue's mobile phone and Bill's mobile phone). The network 12 is a conventional mobile phone network. It will be appreciated, however, that other types of networks and portable electronic devices may be utilized without departing from the scope of the invention.

The system 10 further includes a video (data) share server 16 connected to the network 12. The video share server 16 is a conventional server to the extent it enables sharing of video data (such as streaming video data) between respective portable electronic devices 14. Data to be shared between a source device 14 and a destination device 14 is routed through the video share server 16. The video share server 16 may be part of a service provided to subscribers of the mobile network.

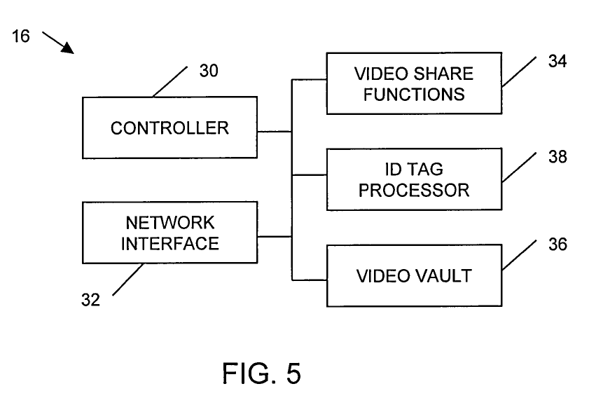

Unlike conventional data share servers, however, the video share server 16 further includes a video vault (discussed in more detail below in relation to FIG. 5). The video vault functions to store data that passes through the video share server 16 en route from the source device 14 to the destination device 14. The video share server 16 copies the data file or stream as it is shared and stores the data in the video vault with a corresponding identification tag. In the exemplary embodiment, the video share server 16 assigns an identification tag that is unique to the corresponding video data copied and stored in the video vault. The video share server 16 provides to the source device 14 the particular identification tag associated with the shared video data. Thereafter, when the source device 14 wishes to share the same data with the same or another destination device 14, the source device 14 need only provide the video data server 16 with the particular identification tag and the identity of the intended destination device 14. The video data server 16 will in turn transmit the corresponding video data stored in the video vault to the intended destination device 14. Consequently, the source device 14 does not waste network bandwidth retransmitting the data to be shared.

As an example, Bill and Sue may establish a video share connection via the network 12 and video share server 16 for streaming video. Bill may use a built-in video camera included in his mobile phone 14 to produce streaming video of a real-time event (e.g., automotive race). Bill's mobile phone 14 thus serves as a source device 14 in streaming the video to Sue's mobile phone 14 serving as the destination device. During such video share session, the video share server 16 caches, captures or otherwise copies the streaming video and stores the copy in its video vault as described above. The video share server 16 provides the unique identification tag to Bill's mobile phone 14, either before, during, or after copying of the video data in the video share session. The identification tag may then be stored in Bill's mobile phone 14 in association with the video itself.

Should Bill later be talking to Sally and she indicates she would like to view the video, Bill can share the video with Sally by providing the corresponding identification tag and identity of Sally's mobile phone 14 (not shown) to the video share server 16. The video share server 16 in turn retrieves the video data from the video vault and transmits the video data to Sally's mobile phone 14. The video share server 16 may stream the video data to Sally's mobile phone 14, or simply provide the video data as a complete file, for example. At the time Bill's mobile phone 14 issues a request that video be shared with Sally's mobile phone 14, Bill and Sally may or may not be talking to one another via their mobile phones 14. Moreover, Bill and Sally's mobile phones 14 may or may not already be connected to one another via the video share server 16. To the extent Bill and Sally's mobile phones 14 are not already connected to the video share server 16 at the time of making or fulfilling a request to share video, the respective mobile phones 14 and the video share server 16 are configured to connect to one another via the network as will be appreciated.

Note that in an alternative embodiment, the source of the video data (e.g., Bill's mobile phone 14) may itself assign a unique identification tag to the video data being shared. The source device 14 can then provide to the data server 16 the identification tag to be associated with the video data for subsequent use.

FIG. 2 represents data management information maintained in Bill's mobile phone 14 in accordance with the exemplary embodiment of the invention. The management information includes a list of the identification tags (e.g., TAGxxx2, TAGxxx3, etc.) and corresponding video data files (e.g. VIDEO2, VIDEO3, VIDEO5, etc.). The video data files may or may not be stored locally in memory within Bill's mobile phone 14 (e.g., Local Store=Y/N). As will be appreciated, data that has previously been shared by Bill and thus captured and stored in the video share server 16 need no longer remain stored in Bill's mobile phone 14. This of course frees up memory space. Alternatively, Bill may choose to retain particular video data files in memory despite having already been shared. Those video data files that have not been previously shared (e.g., VIDEO1 and VIDEO4) will not yet include the identification tag according to the exemplary embodiment. Data that is currently being acquired and streamed for the first time (e.g., VIDEOn) may also be identified in the management information.

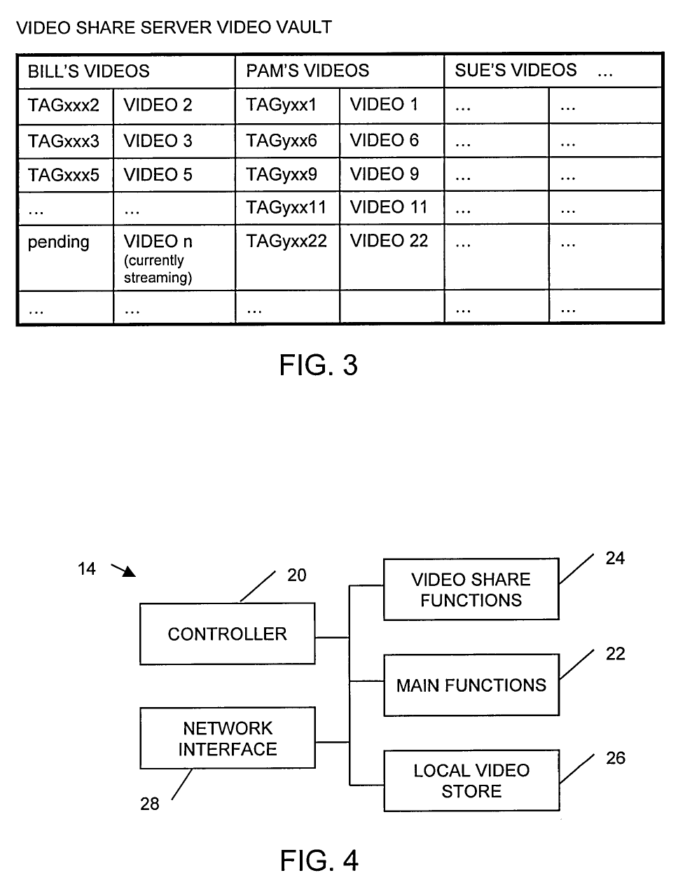

FIG. 3 illustrates corresponding data management information maintained in the video vault of the video share server 16. Since the video share server 16 copies and maintains video data for multiple users (e.g., Bill, Pam, Sue, etc.) within the network 10, the data management information includes the identification tag and corresponding stored video data for multiple users. When the video share server 16 receives a request to share video together with a respective identification tag, the video share server 16 retrieves the corresponding stored video data from the video vault and provides the data to the intended recipient.

FIG. 4 is a schematic block diagram of a mobile phone or other portable electronic device 14 in accordance with the present invention. The device 14 includes a controller 20 configured to carry out the operations described herein. The device 14 further includes a section 22 for carrying out the main functions of the device 14 (e.g., mobile phone communications, camera operation, media recording and reproduction, etc.). Additionally, the device 14 includes a section 24 for carrying out video share functions in conventional manner except as provided herein. In addition, the device 14 includes a local video store section 26 for storing and maintaining videos and management information such as that shown in FIG. 2. Moreover, the device 14 includes a network interface 28 that permits the device 14 to connect to the network 12 (e.g., a conventional mobile phone network interface). A manner for programming the controller 20 together with the video share function section 24 and the local video store function 26 to function in accordance with the operation described herein will be readily apparent to those having ordinary skill in the art of programming and network communications. Consequently, additional detail has not been described herein.

FIG. 5 is a schematic block diagram of the video share server 16. The video share server 16 includes a controller 30, network interface 32 and video share function section 34 configured to operate in conjunction with the corresponding features of the portable electronic devices 14. The video share server 16 further includes a video vault 36 as discussed above in relation to FIG. 3. As previously noted, the video vault 36 stores the videos shared by the various users within the system 10. An identification tag processor section 38 is configured to assign and maintain the identification tags stored in correspondence with the videos in the video vault 36 as described above. Again, a manner for programming the controller 30 together with the video share function section 34, video vault 36 and identification tag processor section 38 to function in accordance with the operation described herein will be readily apparent to those having ordinary skill in the art of programming and network communications. Consequently, additional detail has not been described herein.

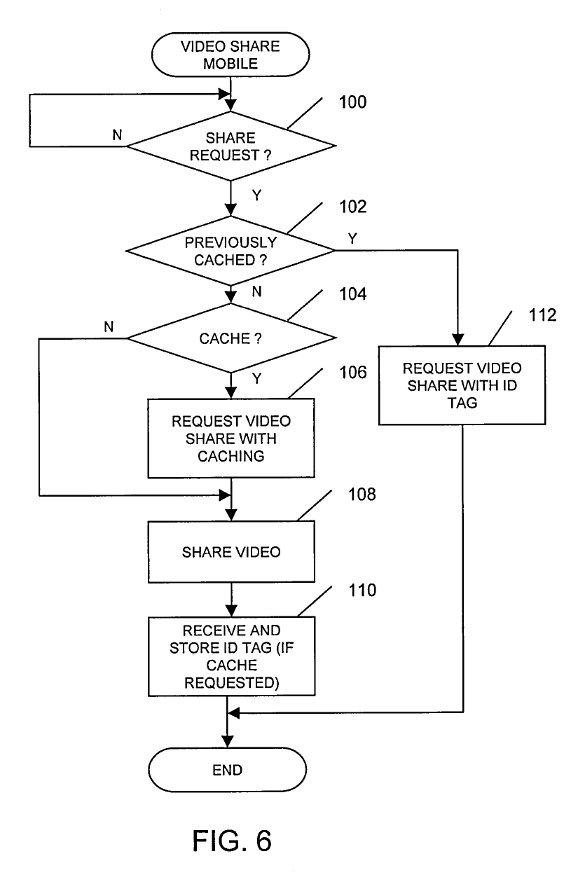

FIG. 6 is a flowchart suitable for programming the operation of the portable electronic devices 14 for carrying out video sharing in accordance with the exemplary embodiment of the present invention. In step 100, the device 14 determines if the user has requested that a selected video be shared with another user in the system 10. The device 14 may be programmed to receive such a request from a user interface included in the device 14, such as via a button or key, pull down menu, etc. As is discussed above in relation to FIG. 2, the request may be in association with a video the user is currently acquiring or about to acquire via a camera included in the device 14. This way, the video may be shared as real-time streaming video with another device 14 in the system 10. Alternatively, the video may be video already stored in the video store 26 in the mobile device. That video data may be shared via streaming or as a complete file, for example, as previously noted.

If the user does not enter such a request to share video in step 100, the device 14 simply continues to loop around step 100. If the user does enter a request to share a video, the device 14 proceeds to step 102 in which the device 14 determines whether the video to be shared has previously been cached and is maintained the video share server 16. Specifically, the device 14 reviews the management information (FIG. 2) stored in its local video store 26. If the video does not already appear in the video store 26, or if the video is stored in the video store 26 but does not have a corresponding identification tag, it is determined that the selected video has not previously been cached in the video share server 16. If the selected video does include a corresponding identification tag in the management information, the device 14 in step 102 determines that the video has been previously cached in the video data server 16.

In the event the device 14 determines in step 102 that the selected video has not been previously cached, the device 14 proceeds to step 104 in which it is determined whether the user wishes the video share server 16 to cache the selected video so as to be maintained in the video vault 36. For example, the device 14 may be configured to prompt the user via a display or the like whether he/she would like for the video to be copied and maintained in the video vault 36 of the video share server 16. If the user responds yes, the device 14 proceeds to step 106 in which the device 14 transmits a request to the video share server 16 via the network 12. The request indicates that the selected video is intended to be shared with a destination device 14 and that it is desired that the video share server 16 copy the data which is shared so that it may be subsequently shared with other devices 14 as described above. Next, in step 108 the device 14 shares the video by transmitting the video to the video share server 16 that in turn transmits it to the destination device 14 as described above. If in step 104 it is determined that the user does not wish that the data to be shared be cached by the video share server 16, the device 14 proceeds directly to step 108 in which the device shares the video with the destination device via the video share server 16 in conventional manner. In another embodiment, step 104 may be omitted such that videos to be shared are cached automatically by the video data server 16 without input from the user.

If the video share server 16 cached the shared video, the device 14 in step 110 receives from the video share server 16 an identification tag identifying the shared video as stored in the video vault 36 (FIG. 3). The device 14 in turn stores the identification tag in the management information as represented in FIG. 2. In addition, the device 14 may be configured to use the management information as represented in FIG. 2 together with any other information (e.g., the identity of the device(s) 14 that received the shared video) in order to create and maintain a type of “media share log” within the device 14. By maintaining such information, a device 14 may keep track of what, with whom, and when video or other data was shared with other devices 14.

Accordingly, if the device 14 wishes to share a video that has already been cached as determined in step 102 by the presence of the identification tag, the device 14 proceeds from step 102 to step 112. In step 112, the device 14 need not retransmit the video to be shared to the video data server 16 as is conventional. Rather, the device 14 merely transmits to the video data server 16 a request that the video stored in the video vault 36 in association with the specified identification tag be shared with the intended destination device 14. In this manner, the video share server 16 transmits the video from the video vault 36 to the destination device 14 without the need for the device 14 to transmit the video to the video share server 16 each time the device 14 wishes to share the video. It will be appreciated that the device 14 in step 112 can even request that the video identified by the identification tag included in the request be shared with more than one destination device 14 specified in the request.

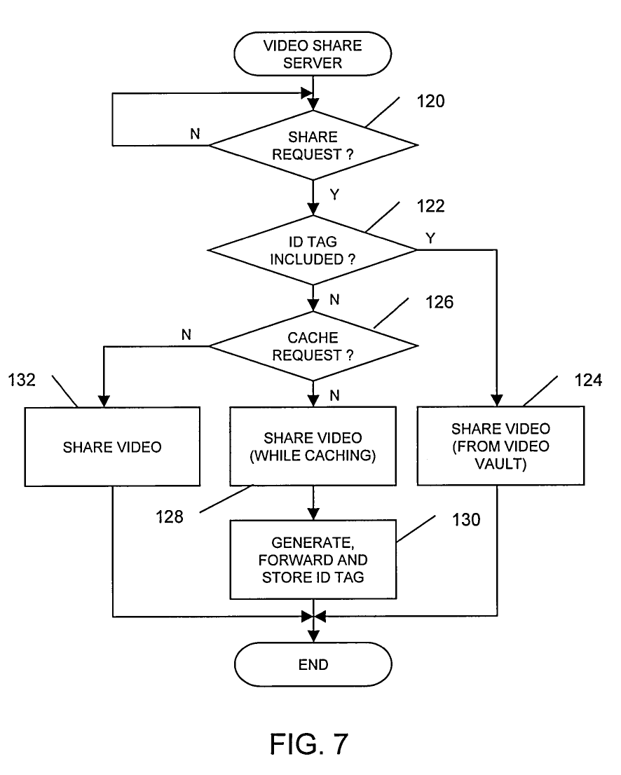

FIG. 7 is a flowchart suitable for programming the video share server 16 to perform in accordance with the operation described herein. In step 120, the video share server 16 determines if it has received a request to share video from a device 14 (e.g., in relation to step 106 or 112 of FIG. 6). If no, the video share server 16 loops around step 120. If yes, the video share server proceeds to step 122 in which it determines whether an identification tag was included with the request (e.g., in relation to step 112 of FIG. 6). If yes, the video share server 16 looks to the video vault management information as in FIG. 3 and identifies the particular video associated with the identification tag. The video share server 16 then proceeds to share the particular video from the video vault 36 with the destination device identified in the request, as represented in step 124. In this manner, it is not necessary that the requesting device 14 again transmit the video to the video share server 16 in order that the video be shared with the destination device 14. Instead, the video share server 16 shares the video with the destination device 14 using the copy stored in the video vault 36. The video share server 16 may stream the data to the destination device 14, simply transmit the complete file, etc., as previously noted.

If an identification tag is not included with the request as determined in step 122, the video share server 16 proceeds to step 126 in which it determines whether the request to share video includes a request that the video be cached by the video share server 16 (e.g., in relation to step 106 of FIG. 6). If yes, the video share server 16 proceeds to step 128 in which the video share server 16 proceeds to share the video provided by the device 14 (in step 108 of FIG. 6) with the destination device 14. During such time, the video share server 16 copies the data being shared and thereafter maintains the copy in the video vault 36. In addition, in step 130 the video share server 130 generates the identification tag to be associated with the shared video in the video vault 36. The video share server 16 stores the corresponding identification tag in the management information as represented in FIG. 3, and forwards the identification tag information to the requesting device 14 (corresponding to step 110 of FIG. 6).

If, in step 126, the video share server 16 determines that a cache request is not included in the share request, the video share server 16 proceeds to step 132. Specifically, the video share server 16 provides the shared data to the destination device 14 in conventional manner.

As will be appreciated, the present invention reduces the amount of bandwidth required to share data via a data share server, whether it be video data or any other type of data.

Further, different variations are possible as will be appreciated. For example, rather than the video share server 16 generating the identification tag in step 130 (FIG. 7), the requesting device 14 may itself generate the identification tag and provide it to the video share server 16. The video share server 16 may then store it in the management information in association with the corresponding copy video. In such case, care should be taken to make sure duplicate identification tags from different devices 14 are avoided. For example, a unique network identifier of the device 14 may be incorporated as part of the identification tag to help ensure uniqueness.

In another variation, a device 14 may obtain an identification tag from another device 14 or from another source. The device 14 may then transmit a request to the video share server 16 requesting that the video stored in the video vault 36 in accordance with the specified identification tag be transmitted to the requesting device. In this manner, it is not necessary for the source device to initiate the transfer.

Regarding a device 14 with whom a video has been shared, the device 14 may be granted various levels of subsequent use/access in accordance with an embodiment of the invention. For example, the device 14 which requested that the video be shared may provide to the receiving device 14 or ask that the video share server 16 provide the receiving device 14 different levels of use/access. In one case, the receiving device 14 is not provided with the identification tag itself or otherwise granted subsequent use or access. Alternatively, the receiving device 14 may receive the identification tag from the device 14, e.g., from the device 14 which originally requested the video share, the video share server 16, or some other source. However, the identification tag may be restricted in use such that the receiving device 14 may or may not be permitted to provide the identification tag to the video share server 16 in order that the video may be shared with yet another device 14. As still another alternative, the identification tag may be restricted in use such that the identification tag or video may be further shared with only a certain number of other devices. In yet another alternative, there may be no limits placed on further sharing of the identification tag or video. In another embodiment, the video share server 16 may be configured to regulate the number of times a video may be shared, which or how many devices 14 may request that a video be shared, etc. In this manner, sharing of videos and content may be regulated as part of digital rights management.

Further, the video share server 16 may limit the amount of data that can be stored in the video vault 36 in association with each user/device 14. For example, users requesting premium service may be entitled to larger storage capacity within the vault 36 compared to users not having premium service. Of course, this aspect of the present invention is in addition to the network bandwidth savings.

In still another variation of the invention, the video share server 16 may provide status information to a device 14 requesting that a video be shared. For example, suppose Bill wishes to share with Sue a video previously stored in the video share server 16. Bill uses his device 14 to request that the video be shared with Sue's device 14 as described above in relation to step 112 (FIG. 6). The video share server 16 may stream the video to Sue's device 14 as previously described, and also provide control information to Bill's device indicating information such as the elapsed time of the video streamed to Sue's device 14. Bill's device 14 may be configured to synchronize the playing of the same video stored locally in Bill's device 14. In this manner, Bill and Sue may be watching the same video simultaneously in the sense that they view the same portions of the video at the same time. Bill and Sue can thus further enjoy the video sharing experience by discussing (via the mobile phone functions) the interesting parts of the video being viewed at the same time. While the video share server 16 provides the full data to Sue's device 14, the video share server 16 need only share relevant control (e.g., timing) information to Bill's device 14. Thus, there is very little increase in overall bandwidth necessary.

While the video share server 16 is described herein as a centralized device, it will be appreciated that various aspects of the server 16 may be distributed across the network without departing from the scope of the invention.

The term “electronic device” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A system for sharing data over a network, the system comprising:
a plurality of portable electronic devices among which data may be shared; and
a data share server through which data to be shared between the plurality of portable electronic devices is routed via the network,
wherein the data share server comprises:
a data share unit for receiving data to be shared from a source portable electronic device among the plurality of portable electronic devices via the network, and for forwarding the data to be shared to a destination portable electronic device via the network; and
a data storage unit for copying the data to be shared and maintaining the copy for subsequent sharing among the plurality of portable electronic devices.

2. The system of claim 1, wherein for each copy of data maintained in the data storage unit, the data storage unit also includes an identification tag respectively associated with the copy.

3. The system of claim 2, wherein the data share unit provides the identification tag respectively associated with each copy of data to at least one of the plurality of portable electronic devices to enable the at least one of the plurality of portable electronic devices to initiate subsequent sharing of each copy of data between the data share server and one of the plurality of portable electronic devices.

4. The system of claim 3, wherein the data share unit provides the identification tag associated with each copy of data to the portable electronic device which served as the source of the data when originally copied.

5. The system of claim 3, wherein the data share unit provides the identification tag associated with each copy of data to one of the plurality of portable devices other than the portable electronic device which served as the source of the data when originally copied.

6. The system of claim 2, wherein the data share unit is configured to receive a request to share each copy of data as identified by the associated identification tag, with one of the plurality of portable devices.

7. The system of claim 6, wherein the request to share is from the portable electronic device which served as the source of the data when originally copied.

8. The system of claim 7, wherein the request to share further includes the identity of the one of the plurality of portable devices with whom the copy of data is to be shared.

9. The system of claim 6, wherein the request to share is from a portable electronic device other than the portable electronic device which served as the source of the data when originally copied.

10. The system of claim 9, wherein the request to share is from the portable electronic device which served as the destination of the data when originally copied.

11. The system of claim 10, wherein the request to share further includes the identity of the one of the plurality of portable devices with whom the given copy of data is to be shared.

12. The system of claim 1, wherein the data to be shared is video data.

13. The system of claim 12, wherein the video data is streaming video data.

14. The system of claim 1, wherein the data to be shared is streaming data.
